(19) United States
(12) Patent Application Publication
(10) Pub. No.: US 2006/0024575 A1
(43) Pub. Date: Feb. 2, 2006

(54) Sealed battery pack

(76) Inventors: Andre C. Robinson, Monroe, GA (US); Due Q. Huynh, Lawrenceville, GA (US); James C. Robinson, Lawrenceville, GA (US)

Correspondence Address: MOTOROLA INC, 600 NORTH US HIGHWAY 45, ROOM AS437, LIBERTYVILLE, IL, 60048-5343, US

(21) Appl. No.: 10/903,693

(22) Filed: Jul. 30, 2004

(51) Int. Cl. H01M 2/08; H01M 2/02; H01M 10/04; B29C 45/14

(52) U.S. Cl. 429/185; 429/7; 429/176; 29/623.2; 264/272.21

(57) ABSTRACT

A sealed battery pack is provided that prevents liquid, dust and gas from compromising the reliability of the rechargeable cell and circuitry disposed within the pack. A rechargeable cell and printed circuit board are coupled together and are placed into a five sided housing. In one embodiment, one of the sides is longer that the others to accommodate electrical contacts for coupling to a host device. Once the cell/board assembly is positioned in the housing, plastic is drawn through the housing using an insert molding process to seal and encapsulate the cell and board within the housing. The seal provided by the insert molding process ensures that liquid, gas and dust do not penetrate the pack.

### BACKGROUND

1. Technical Field

This invention relates generally to rechargeable battery packs, and more specifically to a rechargeable battery pack that is sealed such that the cell within the pack is protected from external gasses liquids.

2. Background Art

Traditional rechargeable battery packs have included a cell, circuitry and a plastic housing. The housing generally comes in two halves, for example a top and a bottom. The cell and circuit are placed into one half of the housing, and the other half is then attached with snaps or screws. The assembled battery pack may then be attached to a portable electronic device like a cellular telephone.

The problem with these prior art designs is that they are not water tight. As such, if liquids like coffee or tea are spilled on the battery packs, the liquid may penetrate the battery housing and compromise the reliability of the rechargeable cell disposed therein. Additionally, some environments, like certain manufacturing plants, have combustible gasses permeating the air. These gasses can be corrosive and may compromise the reliability of the cell and circuitry if allowed to enter a battery pack.

One prior art solution to this “gas and liquid permeability” problem is ultrasonic welding. Essentially, designers attempt to make the seams between housing halves air and water tight by welding them together rather than snapping or gluing them together.

The problem with this prior art solution is that ultrasonic welding requires housings that have thick walls. Generally speaking, the walls of the housing must be at least 2 millimeters thick to be ultrasonically welded. This wall thickness is often too thick for today's miniaturized electronic device.

A second problem with welding involves the exterior contacts. Welding only joins the perimeter seams where the two halves of the housing meet. Since all battery packs have external contacts as well, there is an additional need to seal the space around the contacts. Consequently, another housing part is needed to ensure that liquids and gasses do not penetrate the pack. This additional part increases both materials and labor costs, thereby making the battery pack more expensive.

There is thus a need for an improved battery pack that prevents liquids and gasses from penetrating the housing and compromising the reliability of the rechargeable cell and circuitry.

### BRIEF DESCRIPTION OF THE DRAWINGS

FIGS. 1 and 2 illustrate one preferred embodiment of a housing in accordance with the invention.

FIGS. 3-6 illustrate one preferred embodiment of a printed circuit board in accordance with the invention.

FIG. 7 illustrates one preferred embodiment of a rechargeable cell and printed circuit board assembly in accordance with the invention.

FIG. 8 illustrates a circuit board and cell assembly positioned in a housing in accordance with the invention.

FIG. 9 illustrates a method of insert molding in accordance with the invention.

FIG. 10 illustrates a battery pack in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

A battery pack is provided herein that prevents both liquids and gasses from penetrating the pack housing, thereby improving both the reliability and cycle live of the pack. The battery pack has a five sided housing, where one of the sides is longer than the others. A cell, with a circuit board coupled thereto, is placed within the housing. The housing and cell assembly are then placed in a mold. Low-temperature plastic is then drawn through the housing, thereby sealing the cell and circuit board within the five sided housing. The insert molding process makes the overall battery pack virtually impervious to liquids and gasses.

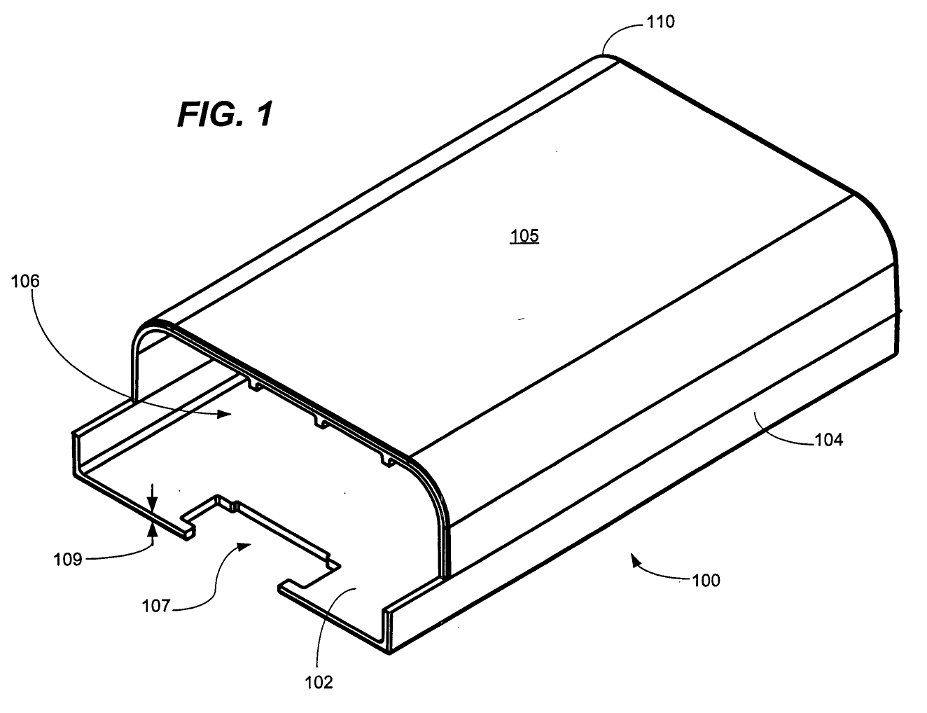

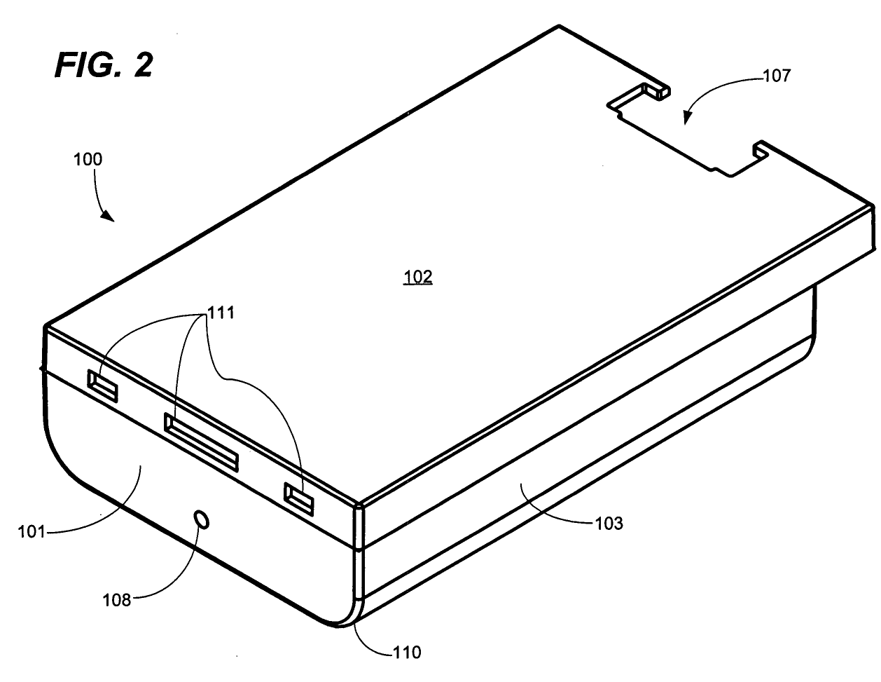

Turning now to FIGS. 1 and 2, illustrated therein is a housing 100 for a battery pack in accordance with the invention. The housing 100 is essentially a five-sided box, with an end piece or end side 101, and four other sides 102-105. One of the sides, side 102, is longer (when measured from the end piece 101 to the opening 106) than the other three sides 103-105. For ease of reference, side 102 will be referred to as the “bottom” side, while side 105 will be referred to as the “top” side. The housing 100 is preferably manufactured from a plastic material like polycarbonate or polycarbonate blends by way of an injection molding process. One example of such a polycarbonate blend is Polycarbonate Acrylonitrile Butadiene Styrene (PC-ABS).

One of the sides 102-105, or the end 101, may include at least one aperture 107 for accommodating electrical contacts. In the exemplary embodiment illustrated in FIGS. 1 and 2, the aperture 107 is located in the bottom 102. Additionally, the end 101 may also include an aperture 108. As will be shown below, the pack is sealed by injecting plastic into the housing 100 through the opening 106. When this occurs, aperture 108, sometimes referred to as a “gas release port”, allows gasses to either be released or drawn from the interior of the housing, thereby facilitating a faster and more even flow of sealing plastic through the housing 100. During the process, gas is transferred out of the five sided box through aperture 108.

As noted above, when ultrasonic welding is used to close two halves of the cell, the wall thickness 109 must be at least 2 mm. With the present invention, experimental results have shown that the wall thickness 109 may be less than 1 mm. As such, a battery pack made in accordance with the invention can be smaller in overall size than prior art packs. Thus, in one preferred embodiment of the invention, the sides 102-105 and end 101 are less than 1 mm thick. It will be clear to those of ordinary skill in the art having the benefit of this disclosure that the walls can be made thicker as applications warrant. Additionally, curves 110 and contours, as well as mating protrusions and detentes 11 may be added to allow the battery pack to couple to a host electronic device.

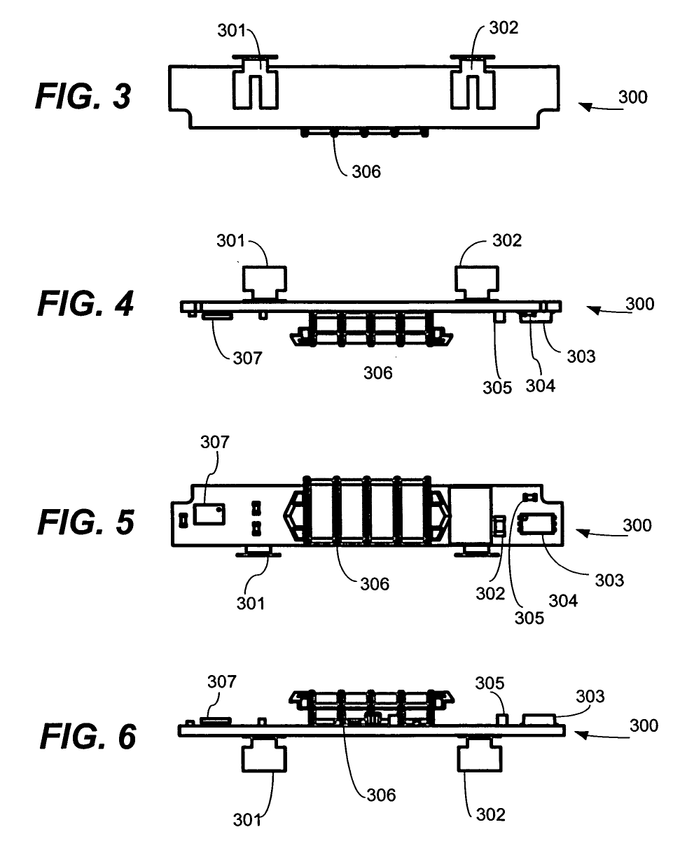

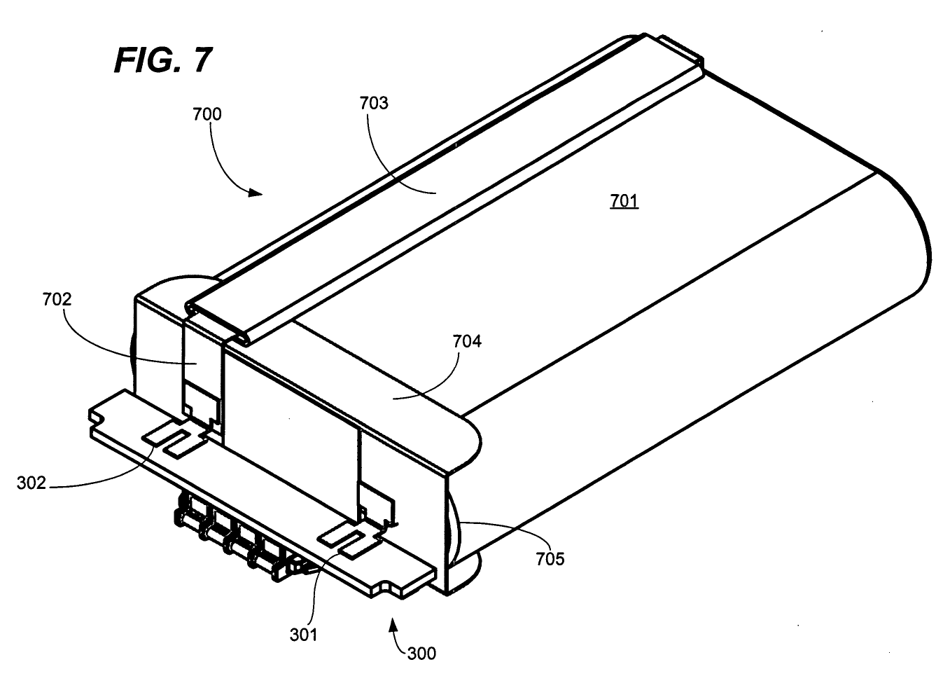

Turning now to FIGS. 3-6, illustrated therein are four views of a printed circuit board 300 in accordance with the invention. The printed circuit board 300 has several functions within the battery pack. First, it provides electrical tabs 301,302 for electrically and mechanically coupling the printed circuit board 300 to a rechargeable cell. Next, it includes electronic circuitry, e.g. components 303-305. The electronic circuitry may include safety circuits to prevent overcharging, charging circuits, fuel gauging circuits and the like.

Next, the printed circuit board 300 includes electrical contacts, like contact block 306. Note that contact block 306 is a surface mount contact block that may be coupled to the board by automated equipment using a reflow solder process. Contact block 306 provides an electrical interface for voltage, current and data between the electronic device and the battery pack. Other devices, like memory 307, may also be included for battery identification and battery monitoring.

Turning now to FIG. 7, illustrated therein is a cell/circuit board assembly 700 in accordance with the invention. A rechargeable cell 701 is coupled to the printed circuit board 300 by way of the metal, electrical tabs 301,302. Additional tabs 702 may be employed to make connections with distant sides of the cell 701. Insulators, e.g. insulators 703,704, may also be used to prevent short circuits within the battery pack.

In this preferred embodiment, the printed circuit board has been attached to the cell 701 such that the printed circuit board 300 is perpendicular to the end 705 of the cell 701. This perpendicular arrangement is so the printed circuit board 300 will be positioned so as to be parallel with one of the sides of the housing. In the exemplary embodiment shown in the figures, the printed circuit board 300 will be parallel with the bottom (element 102 of FIGS. 1 and 2).

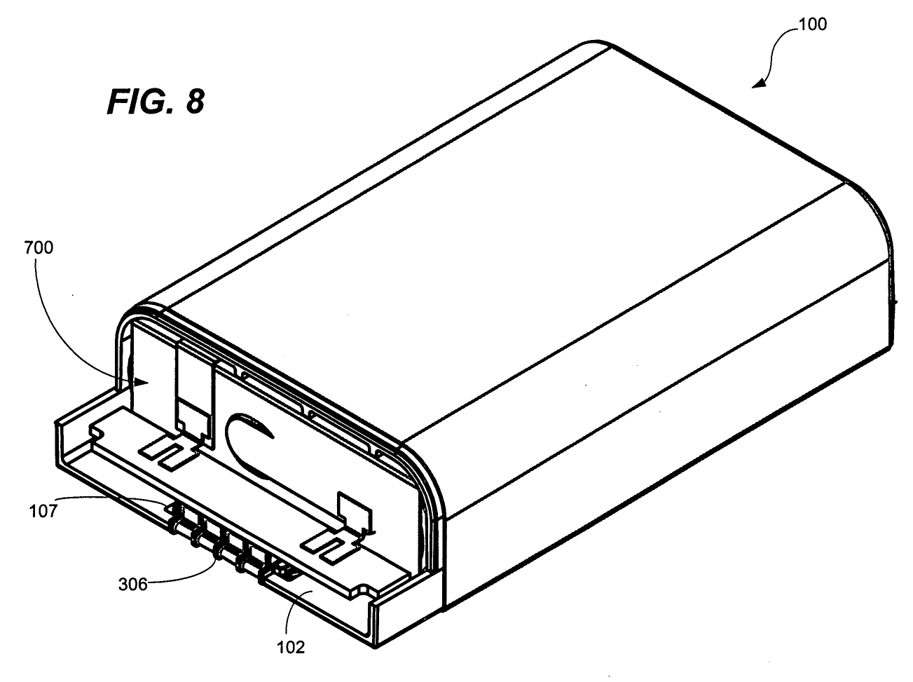

Turning now to FIG. 8, illustrated therein is the cell/board assembly 700 disposed within the housing 100. The contact block 306 has been positioned within the aperture 107 located in the bottom side 102.

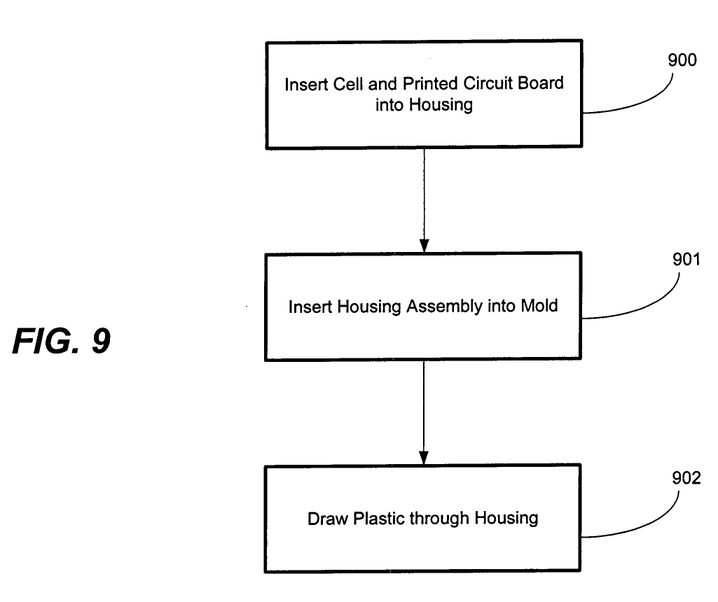

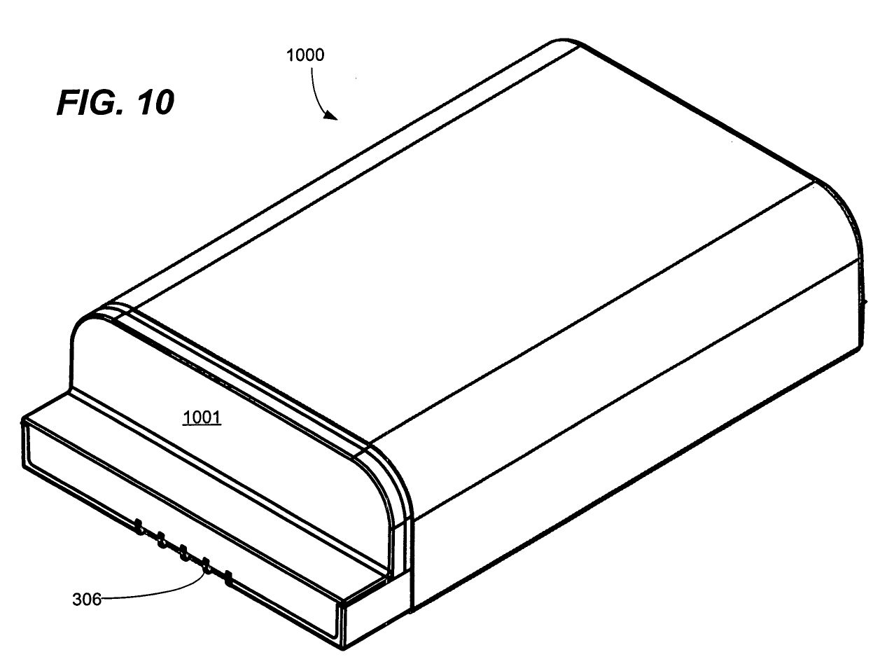

Turning now to FIG. 9, illustrated therein is one preferred method of sealing the battery pack. Once the assembled cell and printed circuit board are inserted into the housing at step 900, the housing is placed in a mold at step 901. An insert molding process is then used wherein low-temperature plastic is drawn through the opening towards the end of the housing. One exemplary plastic that is suitable for such an insert molding process is Macromelt™ OM 638 manufactured by Henkel. The insert molding process, i.e. the process of “filling” plastic throughout the interior of the housing to seal and encapsulate the rechargeable cell and printed circuit board, provides a watertight and airtight battery pack that prevents liquid or gas intrusion. The insert molded plastic additionally mechanically couples the cell and printed circuit board into the housing.

Turning now to FIG. 10, illustrated therein is a completed battery pack 1000 in accordance with the invention. The opening (element 106 in FIG. 1) has now been completely sealed by the insert molded plastic 1001. Additionally, the aperture on the end and the aperture about the contact block 306 have also been sealed by the insert molded plastic 1001. The surface mount contact block 306 is now fixed in a water tight fashion within the aperture in the bottom. The battery pack is now impervious to liquid, dust and gaseous intrusion.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

What is claimed is:

1. A rechargeable battery pack, comprising:
a. a housing having an end piece and four sides, wherein one of the sides is longer than three of the sides;
b. a rechargeable cell disposed within the four sides;
c. a printed circuit board electrically coupled to the rechargeable cell, the printed circuit board mechanically positioned so as to be parallel to one of the four sides; and
d. plastic mechanically coupling the rechargeable cell, printed circuit board and housing.

2. The pack of claim 1, wherein the end piece is less than 1 mm thick.

3. The pack of claim 1, wherein the four sides are less then 1 mm thick.

4. The pack of claim 1, wherein the plastic is deposited by insert molding.

5. The pack of claim 4, wherein the printed circuit board comprises safety circuitry.

6. The pack of claim 5, wherein the printed circuit board us coupled to the rechargeable cell by metal tabs.

7. The pack of claim 6, wherein the printed circuit board comprises a contact block.

8. The pack of claim 7, wherein the one side that is longer than the three sides comprises an aperture, further wherein the contact block is disposed within the aperture.

9. A method of manufacturing a sealed battery, the method comprising the steps of:
a. inserting a rechargeable cell and a printed circuit board into a five-sided box, wherein one side of the five-sided box is longer than other sides of the five-sided box;
b. inserting the five sided box into a mold; and
c. drawing plastic through the box until the rechargeable cell and printed circuit board are encapsulated.

10. The method of claim 9, wherein the five sided box comprises an end side, wherein the end side comprises at least one aperture.

11. The method of claim 10, wherein when the step of drawing is executed, gas is transferred out of the five sided box through the at least one aperture.

12. The method of claim 11, wherein each side of the five sided box has a thickness of less than 1 mm.

13. A sealed battery, comprising:
a. a housing having bottom, wherein the bottom has at least one aperture;
b. a rechargeable cell disposed within the housing; and
c. a printed circuit board having at least a contact block disposed thereon, wherein the contact block is positioned within the at least one aperture;
wherein deposited plastic seals the housing and encapsulates both the rechargeable cell and the printed circuit board, thereby preventing liquid intrusion into the battery.

14. The battery of 13, wherein the bottom is less than 1 mm thick.

15. The battery of claim 13, wherein the deposited plastic is deposited by way of an insert molding process.

16. The battery of claim 15, wherein the housing has an end, wherein the end includes at least one gas release port.
